(19) United States
(12) Patent Application Publication
(10) Pub. No.: US 2004/0085870 A1
(43) Pub. Date: May 6, 2004

(54) Optical disk and optical disk apparatus

(75) Inventors: Kazuo Watabe, Yokohama-shi (JP); Kazuto Kuroda, Kawasaki-shi (JP); Yuuji Nagai, Kawasaki-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/650,130

(22) Filed: Aug. 28, 2003

(30) Foreign Application Priority Data
Aug. 28, 2002 (JP) 2002-248781

(51) Int. Cl. G11B 7/24; G11B 7/095

(52) U.S. Cl. 369/44.34; 369/275.3

(57) ABSTRACT

An optical disk in which tracks in which a header region at which positional information showing a recorded position is recorded and a user region at which user information is recorded are alternately arranged, and in which the user region is made to wobble in a direction perpendicular to the arranging direction are formed, and in which a first region in which at least one of a phase, a frequency, and an amplitude of a wobble is different from the other portions is formed at a portion a given length before the header region in playback order within the user region.

### CROSS-REFERENCE TO RELATED APPLICATIONS

This application is based upon and claims the benefit of priority from the prior Japanese Patent Application No. 2002-248781, filed Aug. 28, 2002, the entire contents of which are incorporated herein by reference.

### BACKGROUND OF THE INVENTION

1. Field of the Invention

The present invention relates to an optical disk on which information can be written, and in particular, to an optical disk in which a pre-pit header including positional information has been recorded in advance at a predetermined position on a track in which the information is recorded.

Further, the present invention relates to an optical disk apparatus which reads and plays back the recorded information from the optical disk described above, and in particular, to an optical disk apparatus which plays back the positional information by estimating an occurring position of the pre-pit header.

2. Description of the Related Art

As is well known, in recent years, an optical disk such as DVD-R (Digital Versatile Disk-Recordable) has been popularized as a mass storage medium on which information can be written at high-density.

On the optical disk, information recording tracks are formed so as to be helical or a concentric circle shape along the circumference thereof. Further, pre-pit headers including positional information are formed at a predetermined length at the tracks.

In the way, when such an optical disk is played back, because a light spot condensed on the optical disk is focus-controlled so as to be a size which does not extend over the pre-pit headers of two adjacent tracks, the effect of crosstalk can be eliminated.

However, in a case of a multiple-structured optical disk, when the light spot is condensed on a recording layer which is on the inner side with respect to an optical head, a light spot whose size extends over the pre-pit heads of the plurality of tracks is formed on a nearer side recording layer, and the effect of crosstalk cannot be bypassed.

Note that the method aiming for an accurate and high-speed access due to the cycle control of an optical disk being made to be highly precise is disclosed in Japanese Patent Application Laid-Open (JP-A) No. 2000-293856. However, there is no description of solving the problem described above.

### BRIEF SUMMARY OF THE INVENTION

According to one aspect of the present invention, there is provided an optical disk comprising:

having tracks in which a header region at which positional information showing a recorded position is recorded and a user region at which user information is recorded are alternately arranged, and in which the user region is made to wobble in a direction perpendicular to the arranging direction; and

having a first region in which at least one of a phase, a frequency, and an amplitude of the wobble is different from the other portions is formed at a portion a given length before the header region in playback order within the user region.

According to one aspect of the present invention, there is provided an optical disk apparatus comprising:

an optical disk which is structured such that tracks are formed in which a header region at which positional information showing a recorded position is recorded and a user region at which user information is recorded are alternately arranged, and in which the user region is made to wobble in a direction perpendicular to the arranging direction, and a first region in which at least one of a phase, a frequency, and an amplitude of the wobble is different from the other portions is formed at a portion a given length before the header region in playback order within the user region;

a light detecting portion which is structured so as to obtain an electrical signal corresponding to the information recorded on the optical disk by condensing a light beam on the optical disk via an objective lens; and

a detecting portion which is structured so as to detect the first region on the basis of the electrical signal obtained at the light detecting portion.

### BRIEF DESCRIPTION OF THE SEVERAL VIEWS OF THE DRAWING

FIG. 1 shows one embodiment of the present invention, and is a cross-sectional view showing for explanation of a structure of an optical disk;

FIG. 2 is a diagram showing for explanation of a recording form of information recorded on the optical disk in the embodiment;

FIG. 3 is a diagram showing for explanation of data layouts at a header region and a user region of the optical disk in the embodiment;

FIG. 4 is a diagram showing for explanation of the details of the vicinity of pre-pit headers of the optical disk in the embodiment;

FIG. 5 is a diagram showing for explanation of wobbles of groove tracks and land tracks of the optical disk in the embodiment;

FIG. 6 is a block diagram showing for explanation of an optical system of an optical disk apparatus in the embodiment;

FIG. 7 is a block diagram showing for explanation of a servo system of the optical disk apparatus in the embodiment;

FIG. 8 is a block diagram showing for explanation of the details of a header sensing circuit in the embodiment;

FIG. 9 is a diagram showing for explanation of wobble signals obtained from the groove track and the land track in the embodiment; and

FIG. 10A and FIG. 10B are respectively diagrams showing for explanation of a common-mode signal and an orthogonal signal which are outputted from the header sensing circuit in the embodiment.

### DETAILED DESCRIPTION OF THE INVENTION

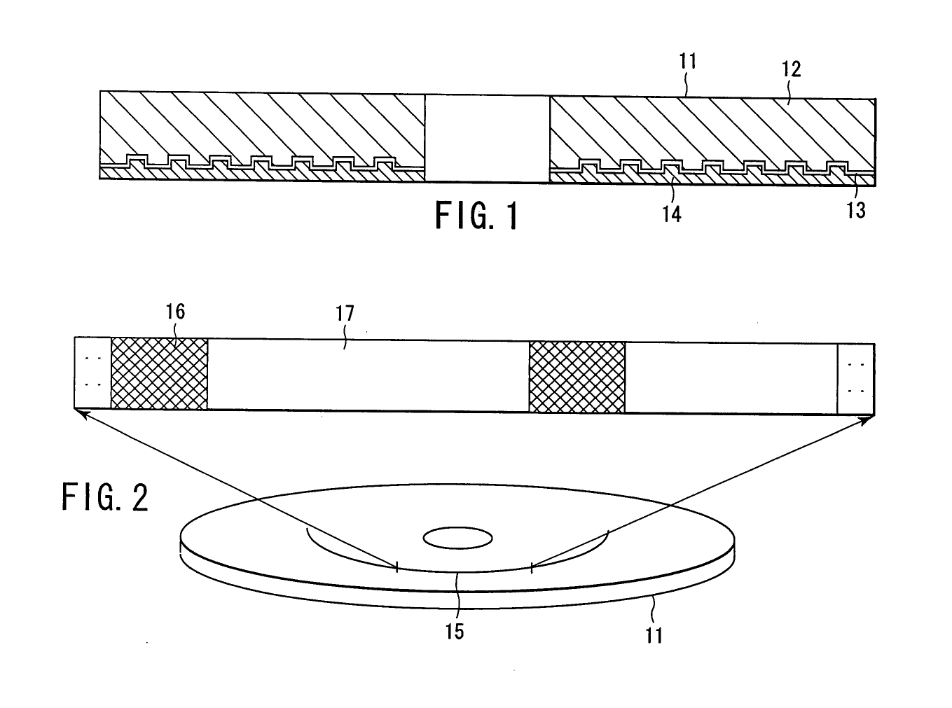

Hereinafter, one embodiment of the present invention will be described with reference to the drawings. FIG. 1 shows a cross section of an optical disk 11 using a pre-formatting system which will be described in this embodiment. Namely, an information recording layer 13 including, for example, a phase change recording film is formed on a substrate 12 formed from a polycarbonate.

Note that, when the optical disk 11 is a playback dedicated disk, the information recording layer 13 is formed from a metallic reflective film in place of the phase change recording film.

Next, a light permeable layer (cover layer) 14 whose thickness is t is formed on the information recording layer 13. This cover layer 14 is a sheet which is formed from, for example, a plastic material, and whose thickness is t. This sheet is glued with an adhesive agent or an ultraviolet curing resin on the information recording layer 13 formed on the substrate 12.

FIG. 2 shows an information recording form on the optical disk 11. An information recording track 15 is formed so as to be helical or a concentric circle shape on the information recording layer 13 of the optical disk 11.

The information recording track 15 is formed from guiding grooves defined by concave portions and convex portions, and information is recorded on a concave portion, a convex portion, or the both portions, for example, by marks due to the changes of phase.

Note that, when the optical disk 11 is a playback dedicated disk, the information track 15 is formed in advance by arrangement of pre-pits.

Further, header regions 16 at which address information or the like is recorded in advance and user regions 17 at which user information is recorded are alternately arranged on the information recording track 15.

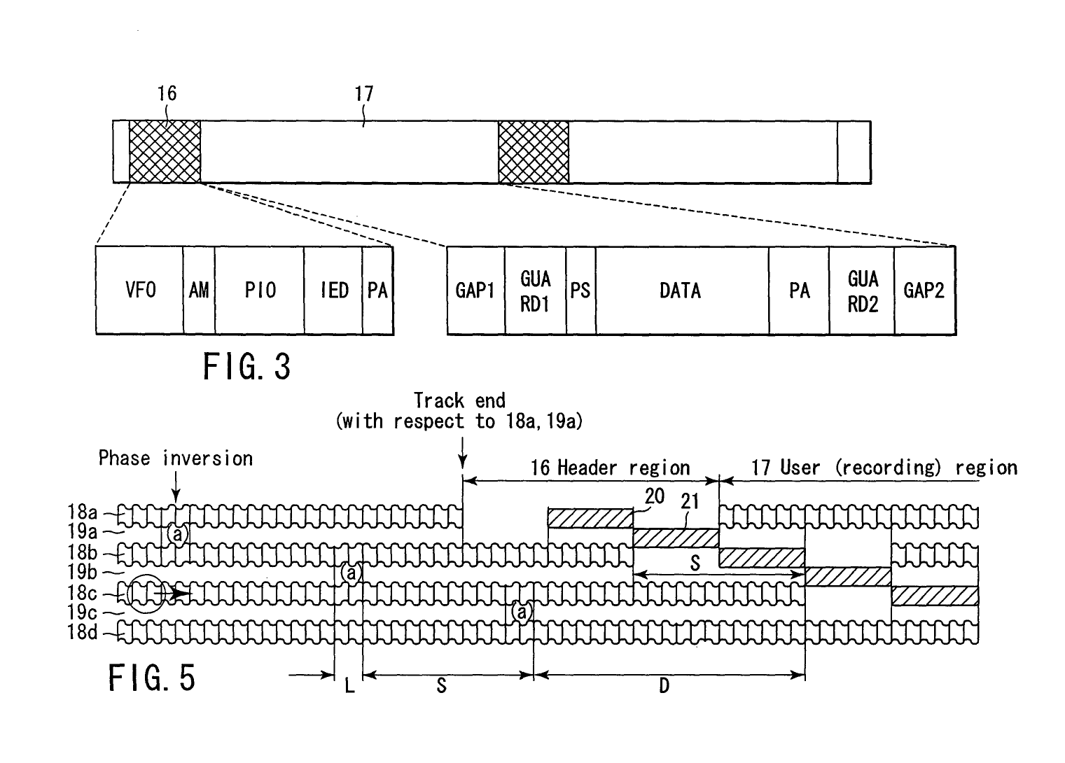

FIG. 3 shows a layout of data at the header region 16 and the user region 17. First, the contents of respective components of the header region 16 is as follows. A VFO field is a field for providing synchronization to a variable frequency oscillator of a phase lock loop having reading channel bits.

An AM field is a field for providing byte synchronization to an optical disk apparatus for the following PID field. The PID field is a field at which data formed from a spare region, a PID number, a sector type, a layer number, a sector number, or the like are stored.

An IED (ID error detecting code) field is a field for detecting an error generated in data of the PID field. A PA field is a field formed from data for completing the last byte of the prior IED field on the basis of a modulation system.

On the other hand, the contents of the respective components of the user region 17 are as follows. A GAP1 field is a field for providing a spare of time from the playback of the header region 16 to writing on the following GUARD field.

The GUARD1 field is a field at which data for preventing deterioration of the starting end of the following PS field is recorded by repeatedly overwriting, and which is for providing synchronization to a variable frequency oscillator of a phase lock loop having reading channel bits.

The PS field is a field for providing byte synchronization for the following data field. A DATA field is a field for recording user data. A PA field is a field formed from data for completing the bytes on the basis of a modulation system following the prior DATA field.

A GUARD2 field is a field at which data for preventing deterioration of the trailing end of the DATA field is recorded, and which is for compensating slippage from an ideal value of an actual recorded data length. A GAP2 field is a field for compensating irregularity of the actual data length by rotational irregularity.

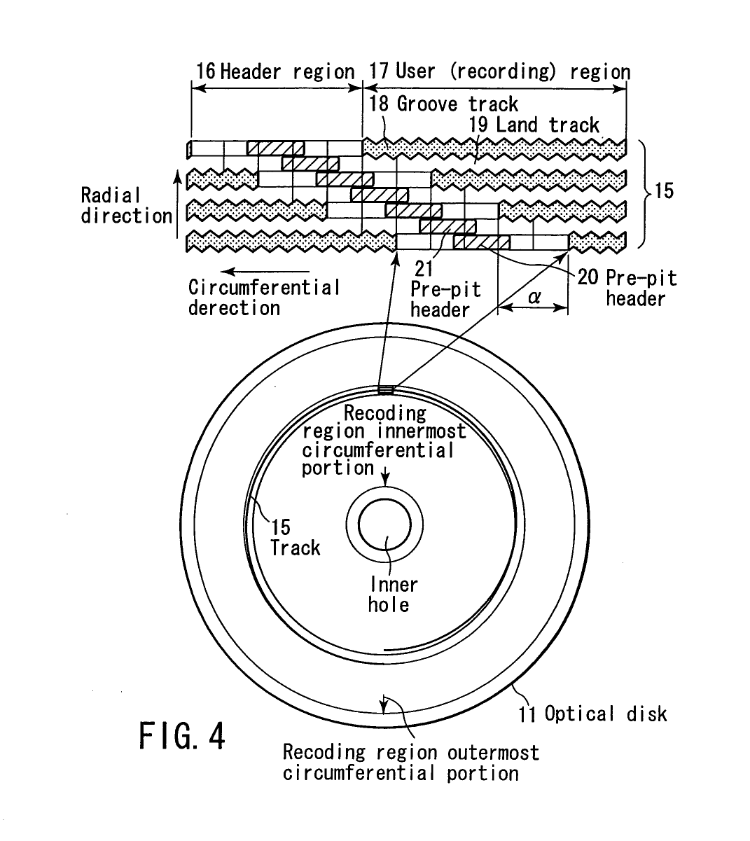

FIG. 4 shows the details at the vicinity of a pre-pit header of the optical disk 11 using the pre-formatting system. The optical disk 11 is an optical disk of a so-called land and groove recording format.

Namely, groove tracks 18 formed from physical concave portions or convex portions, and land tracks 19 relatively formed between the adjacent two groove tracks 18 are arranged as the above-described information recording track 15 at the optical disk 11.

Marks to which the user data are reflected by, for example, changes of phases of the optical disk 11 can be respectively recorded at these groove tracks 18 and land tracks 19.

One set of portions of the heads of the groove tracks 18 and the land tracks 19 are respectively interrupted every recording unit of the user data. Identification information showing, for example, a number (an address) of the recording unit have been recorded in advance as pre-pit headers 20, 21 structured from micro concave portions or micro convex portions in the interrupted region (the header region 16).

The header regions 16 are respectively recorded on the extension lines of the groove tracks 18 and the land tracks 19. At this time, the pre-pit headers 20 on the groove tracks 18 and the pre-pit headers 21 on the land tracks 19 are arranged so as to be shifted by a given length in the circumferential direction between the adjacent tracks 18 and 19. Further, the groove track 18 wobbles at a uniform period.

Note that the method in which the pre-pit headers 20, 21 are shifted by a given length in the circumferential direction between the adjacent tracks 18 and 19 was invented by the same inventor as the present invention, and is disclosed in detail in Japanese Patent Application No. 2001-356237 which was filed by the same applicant.

FIG. 5 shows the vicinity of the header region 16 of the optical disk 11 so as to be enlarged. The pre-pit headers 20, 21 of the groove tracks 18 and the land tracks 19 are recorded at the header region 16.

Note that, in FIG. 5, the groove tracks 18 and the land tracks 19 can be distinguished by denoting subscripts a, b, c, d, and the like to the reference numerals 18, 19 thereof. Further, data including physical positional information (address information) or the like of the optical disk 11 are recorded at the pre-pit headers 20, 21 by pre-pit sequences.

On the other hand, the user region 17 is structured from the groove tracks 18 and the land tracks 19. The header region 16 is a region where the groove tracks 18 and the land tracks 19 are interrupted, and is formed due to each of the adjacent tracks 18, 19 being shifted by a given length S in the track tangent direction.

The groove tracks 18 are made to wobble at a uniform period, and in accordance therewith, the land tracks 19 are made to wobble. At the time of playback or recording of the optical disk 11, a constant frequency signal is played back on the basis of this wobble, and can be used for a rotation synchronizing signal or the like of the optical disk 11.

The groove track 18 comes into the track trailing end (track end) directly before the header region 16, and the wobble is interrupted. Further, the period of the wobble of the groove track 18 is inverted a given length D before the track end. A period in which the period of the wobble is inverted is, for example, two wavelengths (2 wobble) period L.

Further, at the groove track 18, the period of the wobble is inverted further a given length S before the position of the given length D before the track end as well. Here, the above-described given length S is set so as to be equal to the slippage amount S between the adjacent groove tracks 18.

If an inverted portion is formed at the wobble of the groove track 18 in this way, at the land tracks 19 as well, a section (a) where the wobbles at both sides are together inverted by the given length D before the track end is generated.

In this case, referring to FIG. 5, the track end of the land track 19 means the trailing end position of the groove track 18 positioned above the land track 19. For example, the track end of the land track 19a is at the same position as the track end of the groove track 18a.

This is because, for example, referring to the land track 19a, the position where the groove track 18b exists at one side thereof and the groove track 18a does not exist at the other side.

In this way, on the optical disk 11, at both groove track 18 and land track 19, the inverted portions of two wobbles are inserted in the wobbles having a constant period at a position by the given length D before the trailing end portions of the track structures, i.e., the portions where the track structures are interrupted or one track structure of the both sides is broken.

In accordance with the optical disk 11, first, the pre-pit headers 20, 21 are shifted by a given length in the circumferential direction between the adjacent groove track 18 and the land track 19.

Therefore, even when the optical disk 11 is made to be a multi-layered structure, and a light spot is condensed on a recording layer which is on the inner side with respect to an optical head, there is no case in which light spot formed on a nearer side recording layer extends over the pre-pit headers of the plurality of tracks, and the effect of crosstalk can be eliminated.

Further, at the time of playback of the optical disk 11, it is possible for incoming of the track end and the header region 16 to be estimated by detecting the inversion of the period of the wobbles.

Therefore, because the pre-pit headers 20, 21, and in turn, the address information can be rapidly and accurately played back, it is possible for a high speed access to be carried out.

Note that, in the example shown in FIG. 5, the phases of the wobbles at the groove tracks 18 and the land tracks 19 are inverted before the pre-pit headers 20, 21.

However, it is not limited thereto, for example, the frequencies or the amplitudes, or the like of the wooble may be changed, and moreover, the phases, the frequencies, and the amplitudes may be arbitrarily and selectively combined and changed.

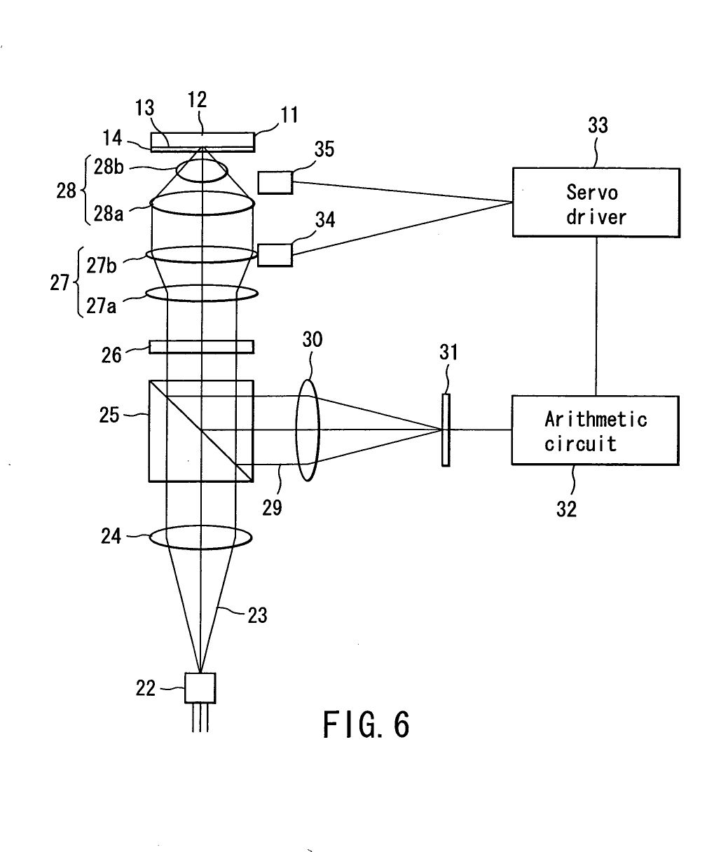

FIG. 6 shows an optical system (optical head) of the optical disk apparatus for carrying out the recording/playback with respect to the optical disk 11 which was described above. Namely, a shorter wavelength semiconductor laser 22 is used as a light service. A wavelength of an outgoing light of the semiconductor laser 22 is in a purple waveband within a range of, for example, 395 nm through 415 nm.

An outgoing light 23 from the semiconductor laser 22 comes into a parrallel light through a collimator lens 24, and permeates a polarizaticon beam splitter 25 and a λ/4 plate 26. Further, after the outgoing light 23 permeates a relay lens system 27, the outgoing light 23 is incident into an objective lens 28. Thereafter, the outgoing light 23 permeates the cover layer 14 of the optical disk 11, and is condensed on the information recording layer 13.

A reflected light 29 by the information recording layer 13 of the optical disk 11 permeates the cover layer 14 of the optical disk 11 again, and retrogresses through the objective lens 28, the relay lens system 27, and the λ/4 plate 26. After the reflected light 29 is reflected at right angles by the polarization beam splitter 25, the reflected light 29 permeates a light detecting system 30 and is incident on a photo detector 31.

A light receiving portions of the photo detector 31 is divided into at least two regions along parting lines which are parallel to the circumferential direction of the tracks of the optical disk 11, and electric current corresponding to a light-intensity is outputted form each light receiving region.

After the outputted electric current is current-voltage converted, the converted electric current is supplied to an arithmetic circuit 32, and is arithmetically processed into an HF (High Frequency) signal, a differential signal of the two-divided light receiving region, a focus error signal and a tracking error signal, or the like.

The HF signal generated at the arithmetic circuit 32 is supplied to playback processing. Further, the differential signal of the two-divided light receiving region, and the focus error signal and the tracking error signal are respectively supplied to a servo driver 33, and are supplied to generation of driving signals provided to driving portions 34, 35.

Here, the above-described relay lens system 27 is structured from a bottom lens 27a and a top lens 27b. The top lens 27b is movable in an optical axis direction. A movement of the top lens 27b is carried out by the above-described driving portion 34. The relay lens system 27 is used for correcting a spherical aberration accompanying with a error in a thickness on the basis of the specific value of the cover layer 14 of the optical disk 11.

Further, the above-described objective lens 28 is structured such that two types of lenses 28a, 28b are combined, and movements of the objective lens 28 to the focusing direction and the tracking direction are carried out by the above-described driving portion 35.

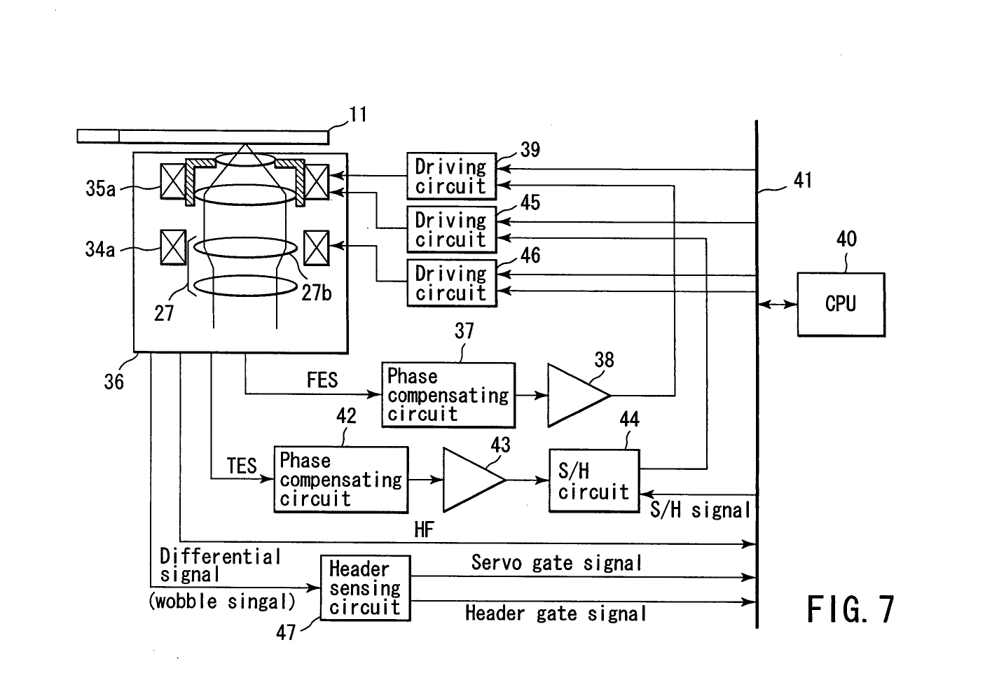

FIG. 7 shows the details of a servo system at the above-described optical disk apparatus. First, at the optical head 36, a focus error signal FES and a tracking error signal TES are generated and outputted by the reflected light from the optical disk 11.

The focus error signal FES is an electric signal corresponding to the slippage in the focus direction of the beam spot irradiated on the information recording layer 13. As a detecting method of a focus error, an astigmatism method, a knife edge method, a spot size detecting method, or the like, which is well known is used. The fact that which method is used for a focus error detecting has no relation to the substance of this invention, and any system may be used.

Further, the tracking error signal TES is an electric signal corresponding to the slippage in the diameter direction from the information recording track 15 of the beam spot irradiated on the information recording layer 13. As a detecting method of a tracking error, a push-pull method, a DPP (Differential Push-Pull) method, a DPD (Differential Phase Detection) method, or the like, which is well known is used. The fact that which method is used for a tracking error detecting has no relation to the substance of this invention, and any system may be used.

When the optical disk 11 is mounted at the optical disk apparatus, the optical disk 11 is rotation-controlled such that a linear velocity thereof is constant or a number of the rotations thereof is constant by an unillustrated spindle motor. The focus error signal FES is, after an appropriate signal amplification is carried out at an amplifier 38 via a phase compensating circuit 37, inputted to a focus driving circuit 39.

After a CPU (Central Processing Unit) 40 completed advance processings such as rotating of the optical disk 11, lighting of the semiconductor laser 22, or the like, the CPU 40 outputs a focus ON signal to the focus driving circuit 39 via a bus 41.

In accordance therewith, a driving signal is outputted from the focus driving circuit 39 to a focus coil of an objective lens actuator 35a structuring the above-described driving portion 35, and focus control is carried out.

Further, the tracking error signal TES is, after an appropriate signal amplification is carried out at an amplifier 43 via a phase compensating circuit 42, inputted to a tracking driving circuit 45 via an S/H (Sample/Hold) circuit 44.

The CPU 40 outputs a tracking ON signal to the tracking driving circuit 45 via the bus 41 after verifying focus locking. In accordance therewith, a driving signal is outputted from the tracking driving circuit 45 to a tracking coil of the objective lens actuator 35a, and tracking control is carried out.

In the relay lens system 27 correcting a spherical aberration, the top lens 27b thereof is driven in the optical axis direction by the actuator 34a structuring the above-described driving portion 34. The CPU 40 outputs a spherical aberration adjusting signal to the relay lens driving circuit 46 via the bus 41. In accordance therewith, a driving signal is outputted from the relay lens driving circuit 46 to the actuator 34a, and adjustment of a spherical aberration correction amount is carried out.

Here, in the optical disk apparatus, a position directly before the header region 16 on the optical disk 11 is sensed, and the tracking error signal TES is held for a given period. Further, the header region 16 is sensed, and a header gate signal for playing back the pre-pit headers 20, 21 at which the address information are recorded is generated.

Namely, at the groove track 18 and the land track 19, and at the pre-pit headers 20, 21, the physical structures on the optical disk 11 are greatly different. Therefore, there are cases in which the tracking error signal TES obtained at the groove track 18 and the land track 19 cannot be sufficiently and accurately obtained at the pre-pit headers 20, 21.

Therefore, a disposal is adopted in which the tracking servo is prevented from being disturbed at the pre-pit headers 20, 21 by holding the tracking error signal TES directly before the pre-pit headers 20, 21.

In this case, when positions (angles of rotation) where the pre-pit headers occur at the respective tracks are uniform, because the positions (angles of rotation) where the pre-pit headers occur can be estimated even when the optical head moves between the tracks, it is not difficult to send a signal for holding a tracking error signal directly before the pre-pit header.

However, if the positions (angles of rotation) where the pre-pit headers occur are shifted each of the tracks, in particular, when movements of several tracks or more are carried out, the positions (angles of rotation) where the pre-pit headers occur cannot be judged, and it is difficult to hold the tracking error signal directly before the pre-pit headers occur.

Further, the fact that the positions (angles of rotation) where the pre-pit headers occur are obscure means that it is difficult to grasp a playback timing of the pre-pit header, and the playback of the pre-pit header, i.e., the playback of the address is delayed, and reduction of an access speed is brought about.

Therefore, in the optical disk apparatus, coping with holding the tracking error signal TES or the playback of the pre-pit headers 20, 21 is carried out by sensing a position directly before the header region 16 on the optical disk 11.

Namely, at the optical head 36, the wobble signals of the tracks 18, 19 of the optical disk 11 are played back by the differential signal of the two-divided light receiving region. The difference signal is inputted to a header sensing circuit 47. At the header sensing circuit 47, although as the details will be described later, incoming of the header region 16 on the optical disk 11 is sensed, and a servo gate signal is transmitted to the CPU 40 via the bus 41.

At CPU 40, an S/H signal is outputted to an S/H circuit 44 in accordance with a servo gate signal. At the S/H circuit 44, the tracking error signal TES is controlled in accordance with the S/H signal, and at the header region 16 in which the tracking error signal TES from the optical head 36 is disturbed, the tracking servo is stabilized by holding the tracking error signal TES directly before the header region 16.

Further, the header sensing circuit 47 senses an incoming of the header region 16, and transmits the header gate signal to the CPU 40 via the bus 41. At the CPU 40, the address information and the like stored in the pre-pit headers 20, 21 of the header region 16 are effectively played back on the basis of the HF signal by the header gate signal.

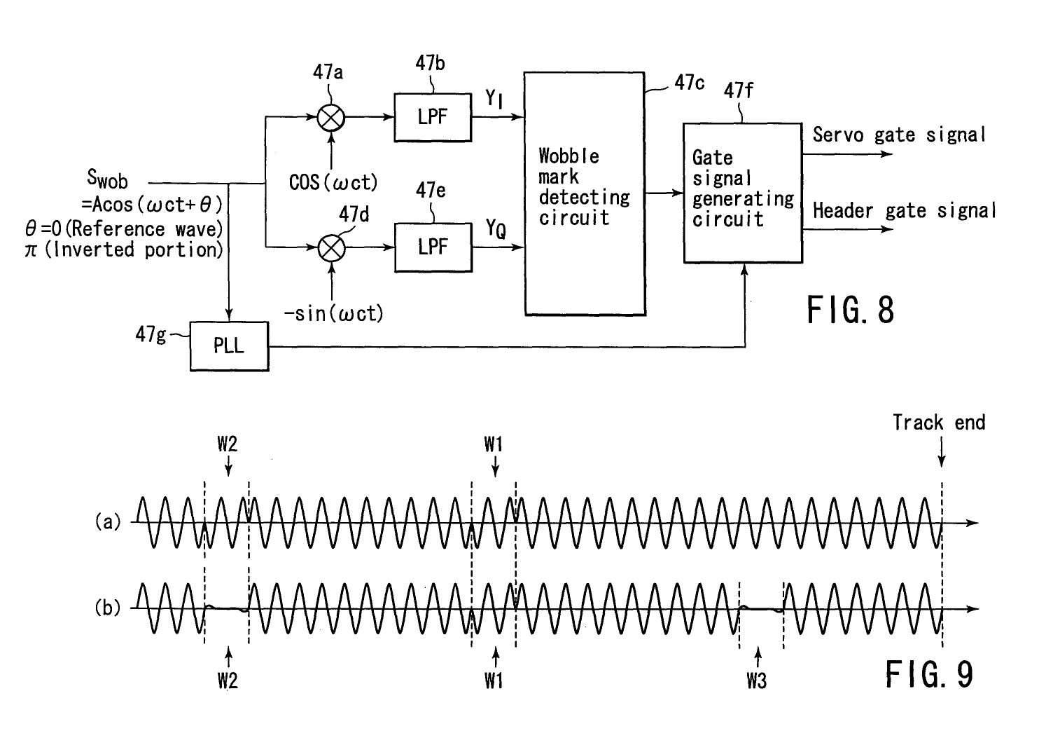

FIG. 8 shows the details of the header sensing circuit 47. Namely, a differential signal (wobble signal) Swob from the optical head 36 is multiplied by a signal cos (ωct) whose phase is the same as the wobbled signal Swob, at a multiplier 47a.

An output of the multiplier 47a becomes a common mode signal Y, by eliminating noise out of the wobble signal band at a low pass filter (LPF) 47b, and is supplied to a wobble mark detecting circuit 47c.

Further, the differential signal (wobble signal) Swob from the optical head 36 is multiplied by a signal −sin (ωct) whose phase is shifted 90°, at a multiplier 47d. An output of the multiplier 47d becomes an orthogonal signal Y_{Q} by eliminating noise out of the wobble signal band at a LPF 47e, and is supplied to the wobble mark detecting circuit 47c.

The wobble mark detecting circuit 47c detects phase inverting signals (wobble mark signals) of the groove track 18 and the land track 19 on the basis of the common mode signal Y_{I} and the orthogonal signal Y_{Q} which were inputted. The wobble mark signals are transmitted to a gate signal generating circuit 47f.

Further, the above-described wobble signal Swob is transmitted to a PLL (Phase Locked Loop) circuit 47g, and a clock synchronizing with the frequency and phase thereof is generated, and the clock is transmitted to the gate signal generating circuit 47f.

At the gate signal generating circuit 47f, a servo gate signal for holding the tracking error signal TES at the header region 16 and a header gate signal for playing back the pre-pit headers 20, 21 of the header region 16 are respectively generated on the basis of the wobble mark signal and the clock from the PLL circuit 47g.

FIG. 9 respectively shows waveforms of the wobble signals Swob at the portions directly before the header region 16 of the groove track 18 and the land track 19.

As shown by region W1 in (a) in FIG. 9, in the wobble signal Swob of the groove track 18, the phases of two wobbles are inverted, for example, twenty wobbles before the track end. Moreover, as shown by region W2, the phases of two wobbles are inverted 20+12 wobbles before the track end.

On the other hand, as shown by region W1 in (b) in FIG. 9, in the wobble signal Swob of the land track 19, as in the same way as in the wobble signal Swob of the groove track 18, the phases of two wobbles are inverted, for example, 20 wobbles before the track end.

Further, as shown by regions W3, W2 in (b) in FIG. 9 the phases of two wobbles come into 0 level 8 wobbles before the track end, and the phases of two wobbles come into 0 level 20+12 wobbles before the track end. This corresponds to a place where the phase of the wobble signal at only one side of the groove tracks 18 which are adjacent to the land track 19 is inverted.

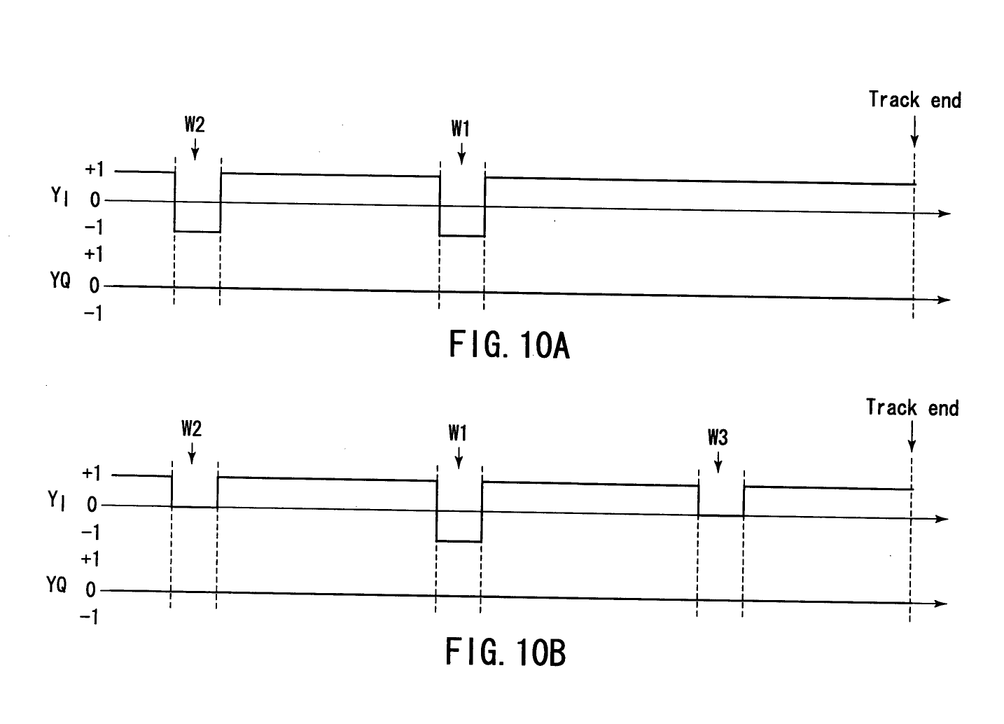

FIG. 10A and FIG. 10B respectively show waveforms of the common mode signal Y_{I} and the orthogonal signal Y_{Q} it the header sensing circuit 47. FIG. 10A is the signal waveform at the groove track 18. The common mode signal Y_{I} comes into −1 at the regions W1, W2 where the phase of the wobble signal Swob is inverted, and comes into +1 at the regions other than them. Further, the orthogonal signal Y_{Q} continuously is 0.

FIG. 10B is the signal waveform at the land track 19. The common mode signal Y_{I} comes into −1 at the region W1 where the phase of the wobble signal Swob is inverted, and comes into +1 at the regions W2, W3 where the wobble signal comes into 0 level. Further, the orthogonal signal Y_{Q} continuously is 0.

Accordingly, at the both of groove track 18 and land track 19, a phase inversion of the wobble signal, i.e., a signal expressing a position a given length before the track end can be detected by judging a signal level of the common mode signal Y_{I}.

Namely, it can be estimated that the track end will come 20 wobbles later by detecting a timing when the signal level of the common mode signal Y_{I} shifts from +1 which is a level corresponding to the reference wobble to −1 which is a level corresponding to the phase inversion wobble.

Here, examples of detecting of the track end and generation of the header gate signal for playing-back the pre-pit headers 20, 21 in the case of the optical disk 11 as shown in FIG. 5 will be described.

However, in FIG. 5, when various physical lengths are expressed in unit of one wobble wavelength, S is 12 wobble, D is 19 wobbles, L is 2 wobbles, and the lengths of the pre-pit headers 20, 21 are 6 wobbles.

During the recording or the playing-back at the user region 17, the reference wobble signal is continuously outputted as a differential signal of the two-divided light receiving region up to directly before the header region 16. At the groove track 18, a phase inversion wobble signal is detected over 2 wobbles, 33 wobbles before the track end, and the level of the common mode signal Y_{I} of the header sensing circuit 47 varies from +1 to −1.

Further, gate signal generating circuit 47f starts to count output clocks of 19 wobbles of the PLL circuit 47g from the time immediately after the common mode signal Y_{I} comes into −1 over 2 wobbles and returns to +1.

However, because the common mode signal Y_{I} comes into −1 over 2 wobbles and returns to +1 again from the time immediately after 10 wobbles are counted, the count of clocks is reset, and the count of 19 wobbles is started again.

After the count of the 19 wobbles, at the gate signal generating circuit 47f, servo gate signals of 18 wobbles of the tracking error signal TES are generated, and are inputted to the S/H circuit 44 via the bus 41. In this way, while the header region 16 is being played back, the tracking error signal TES holds the signal directly before the header region 16.

On the other hand, at the gate signal generating circuit 47f, after the common mode signal Y_{I} transits from −1 to +1 again, output clocks of 25 wobbles of the PLL circuit 47g are counted.

Further, after the count of the 25 wobbles, header gate signals of the pre-pit header 20 are generated over 6 wobbles. The period when the header gate signals are open is the timing when the pre-pit header 20 is played back.

Further, at the land track 19, the phase inversion wobble signals are detected over 2 wobbles, 21 wobbles before the track end, and the level of the common mode signal Y_{I} of the header sensing circuit 47 varies from +1 to −1.

Here, the gate signal generating circuit 47f starts to count output clocks of 19 wobbles of the PLL circuit 47g from the time immediately after the common mode signal Y_{I} comes into −1 over 2 wobbles and returns to +1.

Further, after the count of the 19 wobbles, at the gate signal generating circuit 47f, servo gate signals of 30 wobbles of the tracking error signal TES are generated, and are inputted to the S/H circuit 44 via the bus 41. In this way, while the pre-pit header 21 and the period of 6 wobbles before and after the pre-pit header 21 are being played back, the tracking error signal TES holds the signal directly before the header region 16.

On the other hand, at the gate signal generating circuit 47f, after the common mode signal Y_{I} transits from −1 to +1 again, output clocks of 31 wobbles of the PLL circuit 47g are counted. Further, after the count of the 31 wobbles, the header gate signals are generated over 6 wobbles. The period when the header gate signals are open is the timing when the pre-pit header 21 is played back.

What is claimed is:

1. An optical disk comprising:
having tracks in which a header region at which positional information showing a recorded position is recorded and a user region at which user information is recorded are alternately arranged, and in which the user region is made to wobble in a direction perpendicular to the arranging direction; and
having a first region in which at least one of a phase, a frequency, and an amplitude of the wobble is different from the other portions is formed at a portion a given length before the header region in playback order within the user region.

2. An optical disk according to claim 1, wherein the header region is formed such that positions of headers are shifted along the arranging direction of the tracks between the tracks which are adjacent to one another.

3. An optical disk according to claim 2, wherein the positional information has been recorded at the header region by a pre-pit and the user information can be recorded by marks due to changes of the phase at the user region.

4. An optical disk according to claim 2, wherein the user region is structured from groove tracks formed from physical concave portions or convex portions, and land tracks formed between the groove tracks which are adjacent to one another.

5. An optical disk according to claim 2, wherein a second region in which at least one of a phase, a frequency, and an amplitude of the wobble is different from the other portions except for the first region is formed at a portion a given length before the first region in playback order within the user region.

6. An optical disk according to claim 5, wherein an interval between the first region and the second region is set in accordance with a length in which the positions of the headers at the header region are shifted along the arranging direction of the tracks between the tracks which are adjacent to one another.

7. An optical disk comprising:
having tracks in which a header region at which positional information showing a recorded position is recorded by a pre-pit and a user region at which user information is recorded are alternately arranged, and in which the user region is made to wobble in a direction perpendicular to the arranging direction; and
having a region in which a phase of the wobble is inverted to the other portions at a portion a given length before the header region in playback order within the user region.

8. An optical disk apparatus comprising:
an optical disk which is structured such that tracks are formed in which a header region at which positional information showing a recorded position is recorded and a user region at which user information is recorded are alternately arranged, and in which the user region is made to wobble in a direction perpendicular to the arranging direction, and a first region in which at least one of a phase, a frequency, and an amplitude of the wobble is different from the other portions is formed at a portion a given length before the header region in playback order within the user region;
a light detecting portion which is structured so as to obtain an electrical signal corresponding to the information recorded on the optical disk by condensing a light beam on the optical disk via an objective lens; and
a detecting portion which is structured so as to detect the first region on the basis of the electrical signal obtained at the light detecting portion.

9. An optical disk apparatus according to claim 8, further comprising:
a control portion which is structured so as to control the objective lens in a tracking direction by a tracking error signal with respect to the objective lens which is generated on the basis of the electrical signal obtained at the light detecting portion; and
a holding portion which is structured so as to hold the tracking error signal supplied to the control portion in accordance with the first region being detected by the detecting portion.

10. An optical disk apparatus according to claim 8, further comprising:
a generating portion which is structured so as to generate a gate signal showing a playback timing of the header region in accordance with the first region being detected by the detecting portion, wherein
the information at the header region is played back from the electrical signal obtained at the light detecting portion on the basis of the gate signal generated at the generating portion.
